(19) United States
(12) Patent Application Publication
(10) Pub. No.: US 2017/0038045 A1
(43) Pub. Date: Feb. 9, 2017

(54) WALL LAMP

(71) Applicants: CHAMP TECH OPTICAL (FOSHAN) CORPORATION, Foshan (CN); Foxconn Technology Co., Ltd., New Taipei (CN)

(72) Inventors: ZHONG-HE LIANG, Foshan (CN); QIAN XIANG, Foshan (CN)

(73) Assignees: FOXCONN TECHNOLOGY CO., LTD., New Taipei (TW); CHAMP TECH OPTICAL (FOSHAN) CORPORATION, Foshan (CN)

(21) Appl. No.: 14/861,722

(22) Filed: Sep. 22, 2015

(30) Foreign Application Priority Data
Aug. 7, 2015 (CN) 201510479870.6

(51) Int. Cl. F21V 21/30; F21S 8/00; F21V 29/76; F21V 23/06; F21V 23/02

(52) U.S. Cl. CPC F21V 21/30; F21V 23/06; F21V 23/02; F21V 29/767; F21S 8/033; F21Y 2101/02

(57) ABSTRACT

A wall lamp includes a lamp body, a connector, a power box, a light emitting unit and a driving device. The light emitting unit is fixed on a bottom of the lamp body. The driving device is received in the power box and supplies power for the light emitting unit. The connector includes a first connecting part and a second connecting part. The first connecting part is fixed on a top of the lamp body. The second connecting part is fixed on a top of the power box. The first connecting part is rotationally connected to the second connecting part, thereof adjusting illumination angle of the light emitting unit and making the wall lamp in a closed state or unfolded state.

### CROSS-REFERENCE TO RELATED APPLICATIONS

This application claims priority to Chinese patent application no. 201510479870.6 filed on Aug. 7, 2015, the contents of which are incorporated by reference herein.

### FIELD

The subject matter herein generally relates to an illumination device, especially relates to a wall lamp.

### BACKGROUND

LEDs have advantages of energy saving, environmental protection, long life, high color rendering index and so on. LED lamps belong to landscape lighting. So consumers want products more beautiful in the pursuit of product function at the same time. In addition, a conventional wall lamp including LEDs is directly fixed on the wall or other places, thereof an illumination angle of the wall lamp being limited.

### BRIEF DESCRIPTION OF THE DRAWINGS

Implementations of the present technology will now be described, by way of example only, with reference to the attached figures:

FIG. 1 is an assembled, isometric view of a wall lamp in accordance with an exemplary embodiment of the present disclosure shown in a closed state.

FIG. 2 is an assembled, isometric view of the wall lamp in FIG. 1 shown from another aspect.

FIG. 3 is an exploded, isometric view of the wall lamp in FIG. 2.

FIG. 4 is an assembled, isometric view of the wall lamp in FIG. 2 shown in an unfolded state.

FIG. 5 is a left-side elevational view of a lid of the wall lamp in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially rectangular” means that the object resembles a rectangle, but can have one or more deviations from a true rectangle. The term “comprising” when utilized, means “including, but not necessarily limited to”; it specifically indicates open-ended inclusion or membership in the so-described combination, group, series and the like.

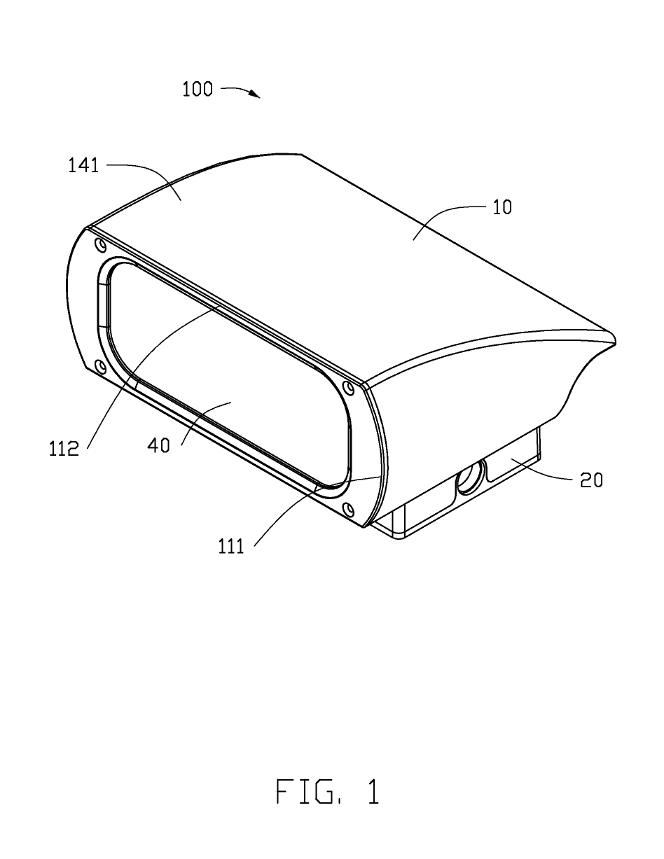

Referring from FIG. 1 to FIG. 3, a wall lamp 100 of the exemplary embodiment in the present disclosure includes a lamp body 10, a power box 20 for receiving a driving device 50 and a connector 30. A light emitting unit 40 is fixed on a bottom of the lamp body 10. The connector 30 rotationally connects the lamp body 10 to the power box 20. Thus the light emitting unit 40 has at least one illumination angle. The driving device 50 is configured to supply power for the light emitting unit 40.

The lamp body 10 is made by one piece via die casting. The lamp body 10 includes a base 11, a first side wall 12, a second side wall 13 and a third side wall 14. The first side wall 12 and second side wall 13 respectively extend from two opposite ends of the base 11 in the same side. The third side wall 14 connects the base 11, the first side wall 12 and the second side wall 13 in the same side of the first side wall 12 and the second side wall 13. The base 11, the first side wall 12, the second side wall 13 and third side wall 14 cooperatively define a cavity 15 therebetween. The base 11 and the third side wall 14 are connected and coupled to form an L-shaped configuration. The third side wall 14 includes s an outer wall 141 and an inner wall 142. The inner wall 142 of the third side wall 14 faces the cavity 15 and the outer wall 141 is back to the cavity 15.

The base 11 is flat. The base 11 is substantially rectangular. The base 11 includes two short sides 111 and two long sides 112. The two short sides 111 can be arc-shaped. In this exemplary embodiment, the two short sides 111 are arc convex. The first side wall 12 and the second side wall 13 respectively extend from the two short sides 111 of the base 11 upwards and vertically. Preferably, the first side wall 12 and the second side wall 13 have the same shape. A width of the first side wall 12 or the second side wall 13 is gradually reduced upwards away the short sides 111 of the base 11. A bottom shape and sizes of the first side wall 12 or the second side wall 13 are the same with that of the short side 111 of the base 11. The third side wall 14 connects to a side of the first side wall 12, a side of second side wall 13 and the long side 112 of the base 11. In this exemplary embodiment, the side of the first side wall 12 and the side of the second side wall 13 connected to the third side wall 14 are arc. In other words, the outer wall 141 of the third side wall 14 is a streamlined curved surface. So the lamp body 10 has a streamlined appearance, thereof being more concise and beautiful.

A plurality of fins 16 are formed on the lamp body 10. Preferably, the fins 16 are formed on the inner wall 142 of the third side wall 14 and the base 11. In this exemplary embodiment, the fins 16 include first fins 161 and second fins 162. The first fins 161 extend from the base 11 to the cavity 15 vertically. The second fins 162 extend from the third side wall 14 to the cavity 15 vertically. Preferably, the first fins 161 are laterally formed on the base 11. The second fins 162 are vertically formed on the inner wall 142 of the third side wall 14. The two adjacent first fins 161 are spaced apart from each other. The two adjacent second fins 162 are spaced apart from each other.

Preferably, a board 17 is configured between the first fins 161 and the second fins 162. The board 17 is parallel to the base 11. The board 17 separates the first fins 161 and the second fins 162. Preferably, the first fins 161 are sandwiched between the base 11 and the board 17. The second fins 162 extend upwards from a top surface of the board 17 along the inner wall 142 of the third side wall 14.

The wall lamp 100 of the exemplary embodiment in the present disclosure further includes a fixed base 18. The fixed base 18 is formed on the lamp body 10 for fixing the connector 30. Preferably, the fixed base 18 is formed on center of the inner wall 142 of the third side wall 14.

The light emitting unit 40 is fixed on a bottom of the base 11 of the lamp body 10. The light emitting unit 40 includes at least an LED 41, a reflector 42 and a lens 43. In this exemplary embodiment, the light emitting unit 40 includes two LEDs 41. In other exemplary embodiments, the light emitting unit 40 can also includes one or a plurality of LEDs 41 to meet different power requirements. The LEDs 41, the reflector 42 and lens 43 are fixed on a bottom of the base 11 of the lamp body 10 that order. The reflector 42 covers the LEDs 41 and the lens 43 covers the reflector 42 to improve the optical properties. Preferably, the light emitting unit 40 further includes a plate 44. The plate 44 is fixed on a bottom of base 11 of the lamp body 10 and presses edges of the lens 43, thereof protecting the lens 43 from abrasion.

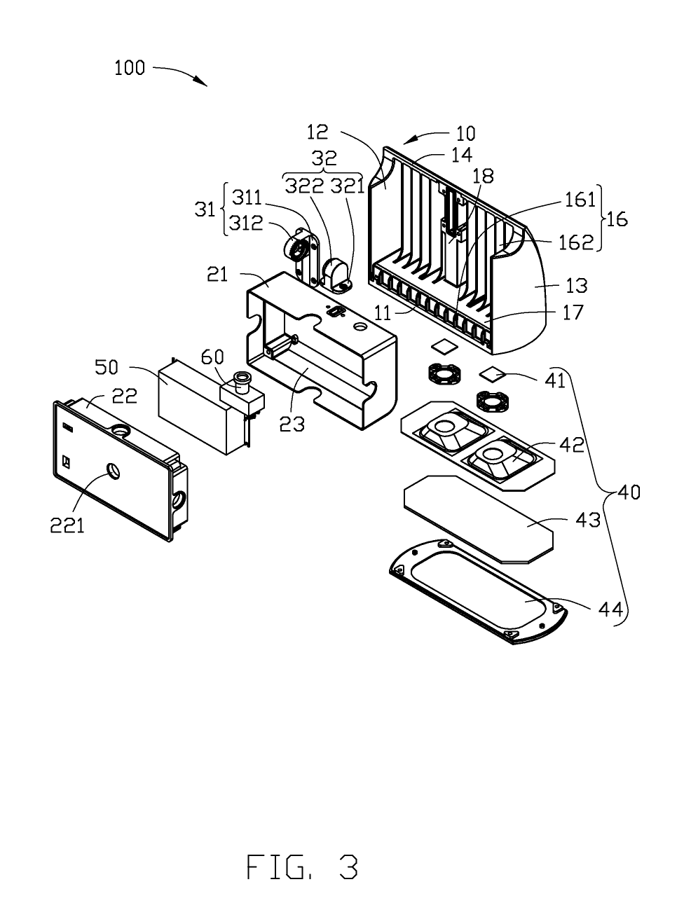

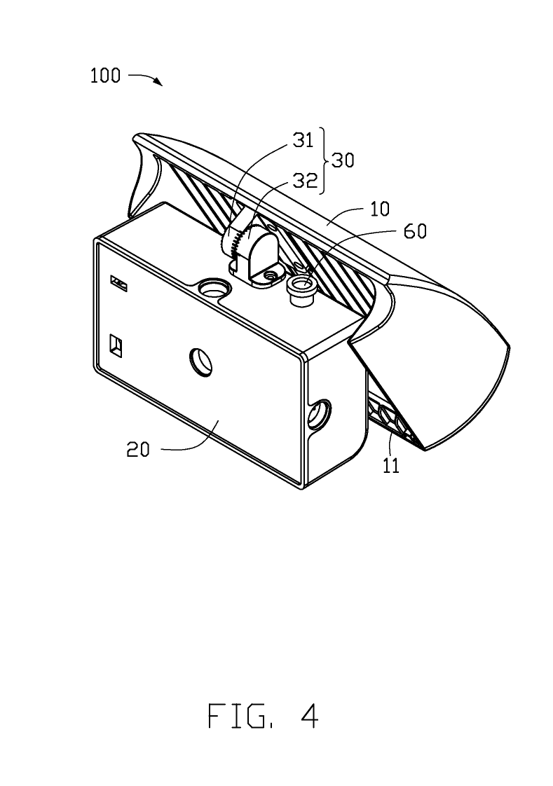

Referring to FIG. 3 and FIG. 4, the power box 20 is coupled to the light emitting unit 40. The power box 20 is rotationally connected to the lamp body 10 via the connector 30. The power box 20 includes a casing 21 and a lid 22. The casing 21 is an open-ended cavity. The lid 22 is coupled with the casing 21 to form a capacity space 23 for receiving the driving device 50. In this exemplary embodiment, the power box 20 is a rectangular body. An opening of the casing 21 is opposite to the lamp body 10. The lid 22 is fixed on the casing 21 via screws. The wall lamp 100 is fastened on a wall via the lid 22 of the power box 20.

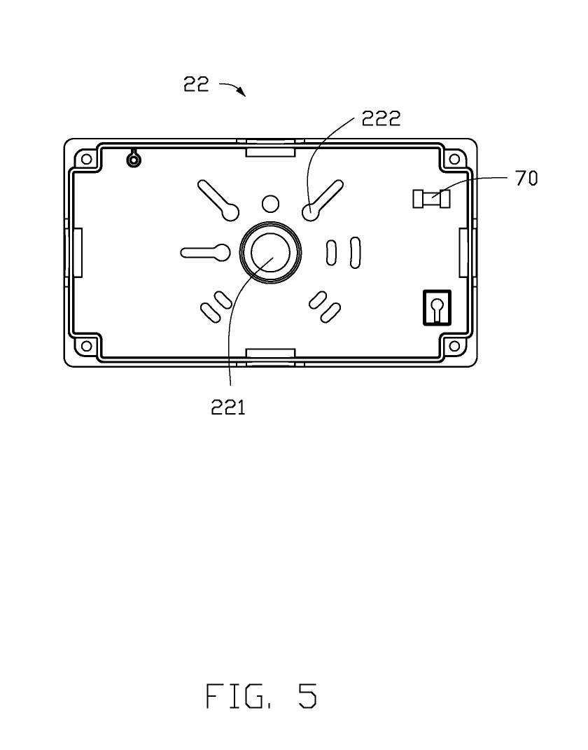

Referring to FIG. 5 at the same time, a through hole 221 and a plurality of mounting holes 222 are defined on the lid 22. The through hole 221 is defined on center of the lid 22 for going through wires of the driving device 50. The mounting holes 222 can be designed according to the standard of Junction boxes of the United States. Thus, power boxes with different sizes can be applied in the wall lamp 100.

Referring to FIG. 4, the connector 30 connects the lamp body 10 and the power box 20 rotationally. In this exemplary embodiment, the connector 30 includes a first connecting part 31 and a second connecting part 32. The first connecting part 31 is rotationally connected to the second connecting part 32, thereby enabling adjustment of the illumination angle of the light emitting unit 40 and enabling the wall lamp 100 to be placed in a closed state or in an unfolded state.

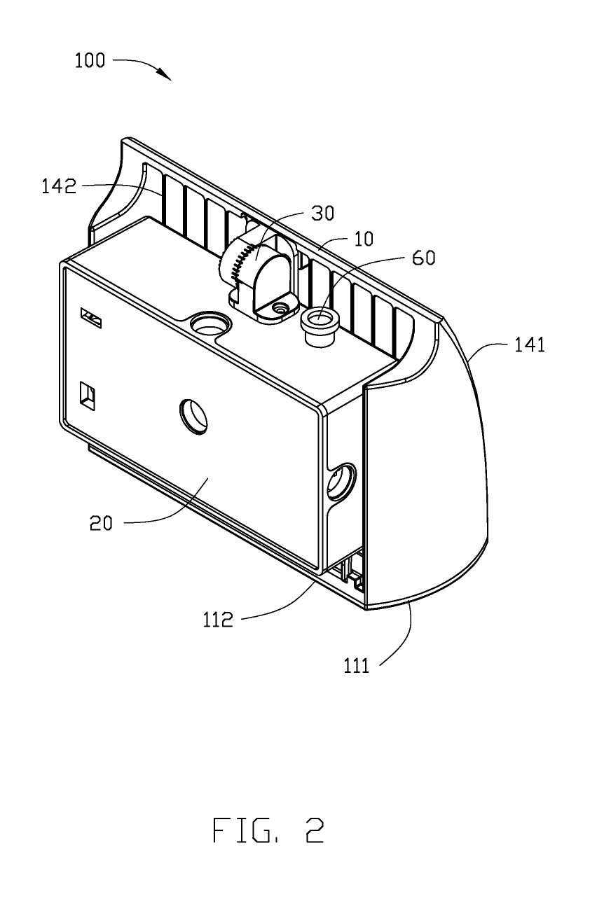

When the wall lamp 100 is in a closed state, the power box 20 is semi received in the cavity 15 of the lamp body 10, as shown in FIG. 2. When the wall lamp 100 is in an unfolded state, the base 11 of the lamp body 10 is gradually upper back via rotating the lamp body 10, thereof separating the lamp body 10 from the power box 20, as shown in FIG. 4. When the wall lamp 100 does not work, the lamp body 10 is rotated to make the wall lamp 100 in a closed state, thereof saving space.

The first connecting part 31 is fixed on a top of the lamp body 10. The second connecting part 32 is fixed on a top of the power box 20. Preferably, the first connecting part 31 is fixed on a center top of the lamp body 10. The second connecting part 32 is fixed on a center top of power box 20. Preferably, the first connecting part 31 is fixed on upper part of the fixed base 18 of the third side wall 14. The second connecting part 32 is fixed on a top surface of the casing 21 of the power box 20.

Referring to FIG. 3 and FIG. 4, preferably, the first connecting part 31 includes a first fixed plate 311 and a first coupled part 312. The first coupled part 312 is formed on the first fixed plate 311. The first coupled part 312 is formed on the edge of the fixed plate 311. The first fixed plate 311 of the first connecting part 31 is fixed on upper part of fixed base 18 of the lamp body 10 via screws with the first coupled part 312 upward. The second connecting part 32 includes a second fixed plate 321 and a second coupled part 322. The second coupled part 322 is formed on center of the second fixed plate 321. The second fixed plate 321 of the second connecting part 32 is fixed on the top surface of the casing 21 of the power box 20 with the second coupled part 322 upward. The first coupled part 312 of the first connecting part 31 is rotationally connected to the second coupled part 322 of the second connecting part 32.

Preferably, the wall lamp 100 of this exemplary embodiment in the present disclosure can further includes a photoreceptor 60 for controlling the wall lamp 100 on or off. The photoreceptor 60 is fixed on a top of the power box 20. Preferably, the photoreceptor 60 is fixed on the top surface of the casing 21 of the power box 20 and is spaced apart from the second connecting part 32.

Compared to the traditional street lamps, the first connecting part 31 fixed on the lamp body 10 of the wall lamp 100 in the present disclosure is rotationally connected to the second connecting part 32 of the power box 20. So the lamp body 10 can be rotated relative to the power box 20 fastened on the wall, thereof adjusting illumination angle of the light emitting unit 40 fixed on a bottom of the lamp body 10. Furthermore, the fins 16 of the wall lamp 100 are formed on the rear surface of the lamp body 10 and the front surface of the lamp body 10 is designed as a streamlined curved surface, thereof making the appearance of the wall lamp 100 more concise and beautiful. In addition, the fins 16 are also designed to be streamline, thereof being aesthetic and forming heat flow cycle to obtain better cooling effect.

Referring to FIG. 5, the wall lamp 100 of the exemplary embodiment in the present disclosure can further include a level 70 fixed on the lid 22 of the wall lamp 100 to make the installation of the lamp wall 100 more accurate. Preferably, the level 70 is fixed on a side of the lid 22 facing the capacity space 23 of the power box 20.

The embodiment shown and described above is only an example. Many details are often found in the art such as the other features of the wall lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wall lamp comprising:
a lamp body;
a light emitting unit fixed on a bottom of the lamp body, the light emitting unit having at least one illumination angle;
a power box;
a driving device received in the power box and configured to supply power to the light emitting unit; and
a connector rotationally connecting the lamp body to the power box;
wherein the connector comprises a first connecting part and a second connecting part, the first connecting part is fixed on a top of the lamp body, the second connecting part is fixed on a top of the power box, and the first connecting part is rotationally connected to the second connecting part, thereby enabling adjustment of the illumination angle of the light emitting unit and enabling the wall lamp to be placed in a closed state or in an unfolded state.

2. The wall lamp of claim 1, wherein a cavity is defined on the lamp body, the power box is semi received in the cavity when the wall lamp is in a closed state.

3. The wall lamp of claim 2, wherein the lamp body comprises a base, a first side wall, a second side wall and a third side wall, and the base, the first side wall, the second side wall and third side wall together form the cavity.

4. The wall lamp of claim 3, wherein the third side wall comprises an inner wall and an outer wall, the inner wall faces the cavity and the outer wall is opposite to the cavity.

5. The wall lamp of claim 4, wherein the first side wall and second side wall respectively extend from two opposite ends of the base in the same side, the third side wall connects the base, the first side wall and the second side wall in the same side of the first side wall and the second side wall.

6. The wall lamp of claim 5, wherein the first side wall and the second side wall have the same shape, and a width of the first side wall or the second side wall is gradually reduced along the direction of the upwards trend.

7. The wall lamp of claim 5, wherein a side of the first side wall and a side of the second side wall connected to the third side wall are arc, and the outer wall of the third side wall is a streamlined curved surface.

8. The wall lamp of claim 4, wherein a plurality of fins are formed on the lamp body, the fins are formed on the inner wall of the third side wall and the base.

9. The wall lamp of claim 8, wherein the fins comprise first fins and second fins, the first fins extend from the base to the cavity vertically, and the second fins extend from the third side wall to the cavity vertically.

10. The wall lamp of claim 9, wherein a board is configured between the first fins and the second fins, the board is parallel to the base, and the board separates the first fins and the second fins.

11. The wall lamp of claim 10, wherein the first fins are sandwiched between the base and the board, and the second fins extend upwards from a top of the board along the inner wall of the third side wall.

12. The wall lamp of claim 4, further comprising a fixed base, wherein the fixed base is formed on center of the inner wall of the third side wall, and the first connecting part is fixed on upper part of the fixed base.

13. The wall lamp of claim 3, wherein the base and the third side wall are connected and coupled to be L-shaped.

14. The wall lamp of claim 3, wherein the light emitting unit is fixed on a bottom of the base, the light emitting unit comprises at least an LED, a reflector and a lens, the reflector covers the LEDs, and the lens covers the reflector.

15. The wall lamp of claim 14, wherein the light emitting unit further comprises a plate, the plate is fixed on a bottom of base of the lamp body and presses edges of the lens.
